(19) United States
(12) Patent Application Publication
(10) Pub. No.: US 2010/0300839 A1
(43) Pub. Date: Dec. 2, 2010

(54) BAGGAGE-INFORMATION SYSTEM FOR A BAGGAGE-DELIVERY BELT

(75) Inventor: Michael Glass, Rodgau Nieder-Roden (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/787,673

(22) Filed: May 26, 2010

(30) Foreign Application Priority Data
May 26, 2009 (DE) 10 2009 022 665.6

(51) Int. Cl. B65G 15/00

(52) U.S. Cl. 198/502.1

(57) ABSTRACT

A baggage-information system is associated with a baggage-delivery belt in an airport. The system can be used analogously both in the arrivals area and in the departure area. In order to create a system which provides information in respect of the baggage fed to a baggage-delivery belt in an airport, it is provided that the baggage-information system contains at least one dynamically updatable display arrangement which is arranged in the immediate vicinity of the baggage-delivery belt and on which can be presented at least the current arrival times and/or the transit times of those baggage items which are located in the system of the baggage-conveying installation and are assigned to the relevant baggage-delivery belt.

### CROSS-REFERENCE TO RELATED APPLICATION

This application claims the priority, under 35 U.S.C. §119, of German application DE 10 2009 022 665.6, filed May 26, 2009; the prior application is herewith incorporated by reference in its entirety.

### BACKGROUND OF THE INVENTION

### Field of the Invention

The invention relates to a baggage-information system for a baggage-delivery belt in an airport for providing current information to the flight passengers and the baggage handlers in respect of the baggage on baggage-delivery belts in the airport.

The baggage-delivery belt in airports, the so-called baggage-reclaim belt, frequently gives cause for irritation as the individual passengers wait at the belt for their baggage item. The flight baggage which is checked in at the check-in counter of the departure airport in order to be transported in the baggage hold of the aircraft is rapidly unloaded from the aircraft upon arrival at the destination airport and is transported, usually by transporting vehicles (dollies or ULDs), into an area of the airport building which the passengers cannot see and where it is positioned, predominantly manually, on a transporting belt leading directly or indirectly to the baggage-delivery belt. There, the baggage items are delivered to the passengers, for removal, in no particular order on an endlessly circulating belt. Each passenger has to identify his baggage item himself and remove it from the belt as the baggage items are moving past. The delivery of baggage is often delayed, in which case the passengers have to wait at the belt.

Since the baggage is conveyed into the reclaim area from the separated-off security area of the airport, where it has been positioned for reclaim on the transporting belt by the baggage handlers, the passenger, or the individual picking up the baggage, sees the latter for the first time when it appears on the baggage-delivery belt. The baggage usually runs through a hatch in the partition wall between the security area and the reclaim area, this hatch being closed by a curtain made of rubber strips or textile strips which block the view into the security area.

As described in the introduction, the baggage is positioned predominantly manually on the belt. For this reason, and because often a number of transporting vehicles or ULDs are unloaded for one flight, there are in some cases relatively large gaps on the transporting belt or the baggage-delivery belt, in which case the passenger waiting at the belt cannot possibly know whether baggage items are still to be expected and, if so, how many. In particular at the end of the unloading operation, it may be the case that passengers wait a long time for their baggage item in some confusion because they are not aware when the unloading operation of the transporting vehicles has ended.

A problem arises analogously where baggage is provided for loading the transporting vehicles or ULDs. This baggage comes from different sources, for example from check-in, from transfer desks and from early check-in or left-luggage stores. It is conveyed onto a baggage-delivery belt and removed therefrom and loaded up. It would be beneficial for the baggage handlers to know how many baggage items to expect for a certain flight, and/or how many baggage items still have to be loaded up, in order for it to be possible, on the one hand, to estimate whether the entire loading quantity is present and, on the other hand, to control the loading process to better effect.

### SUMMARY OF THE INVENTION

It is accordingly an object of the invention to provide a baggage-information system for a baggage-delivery belt which overcomes the above-mentioned disadvantages of the prior art devices of this general type, which provides information in respect of the baggage fed to a baggage-delivery belt in an airport and which provides sufficient information in respect of the baggage items being delivered on the baggage-delivery belts.

In order to achieve the object, it is proposed that the information system contains at least one dynamically updatable display configuration which is arranged in the immediate vicinity of the baggage-delivery belt and on which can be presented at least the current arrival times and/or the transit times of those baggage items which are located in the system of the baggage-conveying installation and are assigned to the relevant baggage-delivery belt. The display system provides the passenger or the baggage handlers with constantly updated information, which allows the passenger or the baggage handlers to estimate when the baggage should arrive or, if the baggage is one of the last to be unloaded, the length of the probable wait.

According to another feature of the invention, it is provided that it is also the case that the total number of baggage items located in the system can be read on the display arrangement, in which case the passenger, or also the baggage handler when loading up the baggage items, can estimate the maximum length of waiting required until the final baggage item arrives.

The display arrangement is preferably a screen on which the information is presented. This information can be projected in a manner used in local public transport in order to indicate the arrival of a bus or of a train by way of the waiting time remaining.

According to one feature of the invention, it is also possible for the beginning and the end of the baggage-delivery process on the relevant baggage-delivery belt to be viewed on the screen of the display arrangement.

It is also conceivable according to the invention to show the beginning and/or the end of the operation of introducing the baggage items into the system such that the same can be read on the display arrangement. The passenger would thus be given the information as to when, or whether, for example the first case has been positioned on the feeding transporting belt and when the operation of unloading the transporting vehicles or ULDs has ended.

If, according to another feature of the invention, the remaining transit time for, and/or the remaining quantity of, baggage located on the baggage-delivery belt is displayed, the passenger, in addition to finding out the maximum amount of time he still has to wait, also knows when not to wait any longer, when the display indicates that all baggage items have passed through (remaining quantity=0). Even if there are cases which have not yet been reclaimed circulating on the belt, he could go to the lost-property office in order to look for his baggage.

The baggage handler at the loading belt can tell, by way of the remaining transit time and/or remaining quantity displayed, that the loading operation for a flight has been completed, that is to say when the remaining transit time has ended and there are no longer any baggage items displayed.

According to the invention, the remaining transit time can be determined by linking baggage recognition and transit-time information. All the data (transporting speed, total quantity, destination information etc.) are present in the master computer of the system and can be used in order to ascertain the information required. It is thus also possible for the information in respect of the total quantity of baggage introduced into the system, and the remaining quantity of baggage located in the system, that is to say not just the baggage items which have arrived on the baggage-delivery belt, to be viewed on the display arrangement. Even in the case of relatively large gaps on the belt, it is possible to tell whether there is still baggage located somewhere in the system which is worth waiting for at the baggage-delivery belt.

According to the invention, it should be possible for at least some pieces of the following dynamically updated information to be shown on a display:

a) current flight number of the incoming baggage;

b) beginning of the baggage delivery in minutes and/or seconds;

c) total number of baggage items for the current flight which are assigned to the baggage-delivery belt;

d) number of outstanding baggage items; and

e) transit time remaining until the final baggage item.

For displaying the beginning of the baggage delivery, a distinction should be drawn between arrivals baggage and departure baggage: in the case of arrivals baggage, as long as baggage is being transported outside the system, this latter state is displayed. When unloading from the terminal-apron transporting device into the conveying installation begins, the beginning of baggage delivery in minutes and seconds is displayed. In the case of departure baggage, prior to the opening time of the baggage belt, the time until this opening time is displayed. From this opening time onward, the expected arrival time of the final case is displayed (this can also increase, in the same way as the total-number and remaining-quantity display).

Other features which are considered as characteristic for the invention are set forth in the appended claims.

Although the invention is illustrated and described herein as embodied in a baggage-information system on a baggage-delivery belt, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a display arrangement before baggage delivery begins according to the invention; and

FIG. 2 is an illustration showing a display arrangement during baggage delivery.

### DETAILED DESCRIPTION OF THE INVENTION

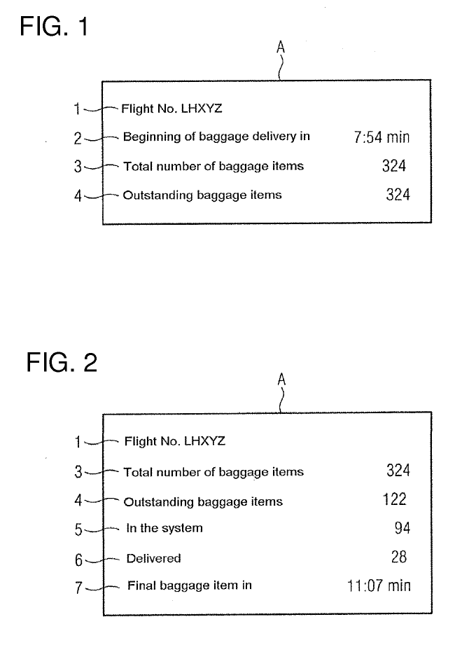

Referring now to the figures of the drawing in detail and first, particularly, to FIG. 1 thereof, there is shown a schematic illustration of how information displayed in respect of baggage to the flight passengers at a baggage-delivery belt could look. In an analogous manner, this information also applies to the displays on the baggage-delivery belts within the conveying and sorting installation from which baggage handlers load terminal-apron transporting device. The information is presented on a display of the display arrangement A, it being possible for the information to be changed dynamically. The display indicates in each case the number of the flight, indicated at 1, for which the baggage is delivered for reclaim on the baggage-delivery belt. If a number of flights are having baggage delivered on the same belt, use is made of a number of displays, or display regions, or the display alternates between the flights. FIG. 1 here illustrates only an example of possible information which is given to the passenger before baggage delivery begins. The beginning of baggage delivery in minutes is indicated at 2, and the time is updated at short intervals, that is to say the minutes indicated are counted down until baggage delivery has begun. In this way, the baggage handlers know when to look out for the incoming baggage and can possibly leave the baggage-delivery belt again or dedicate themselves to other flights. In the line below, 3 indicates for example the total number of baggage items transferred onto the belt, and 4 indicates the number of still outstanding baggage items, this number obviously corresponding, before baggage delivery begins, to the total number of baggage items.

In FIG. 2, once again, 1 indicates the number of the flight for which the baggage is expected. Here too, the total number of baggage items is indicated in the first instance at 3. In addition, the display indicates, at 4, the number of outstanding baggage items, this latter number being constantly updated. It is thus possible for the passenger or the baggage handlers to follow the progress of baggage delivery and to tell when baggage delivery has been completed. It is optionally possible to indicate in addition, as can be seen at 5, how many baggage items are still located in the system of the installation, i.e. including those which have just been positioned on a feeding belt to the baggage-delivery belt. For departure baggage, there are differences between 4 and 5 in baggage items which have already been checked in but have not yet been identified in the conveying system. As illustrated at 6, it is also possible to display those baggage items which have already been sorted and/or delivered. All these numbers are constantly updated and give information in respect of the current situation on the baggage-delivery belt.

It is also possible to indicate, as is illustrated at 7 in FIG. 2, when the final baggage item is expected. This information combined with the number of outstanding baggage items shown can be used by the passenger, for example, to tell when baggage delivery has ended, that is to say when there is no longer any point in waiting in vain for a baggage item which is missing. It is also possible for a list of the still expected baggage items, with individually indicated arrival times, to appear at 7.

1. A baggage-information system for a baggage-delivery belt in an airport for providing current information to flight passengers and baggage handlers in respect of baggage on baggage-delivery belts in the airport, the baggage-information system comprising:
at least one dynamically updatable display configuration disposed in an immediate vicinity of the baggage-delivery belt and on which is presented at least one of current arrival times and transit times of baggage items which are located in a system of a baggage-conveying installation and are assigned to the baggage-delivery belt.

2. The baggage-information system according to claim 1, wherein a total number of baggage items located in the system can be read on said dynamically updatable display configuration.

3. The baggage-information system according to claim 1, wherein said dynamically updatable display configuration is a screen.

4. The baggage-information system according to claim 1, wherein a beginning and an end of a baggage-delivery process on the baggage-delivery belt can be viewed on said dynamically updatable display configuration.

5. The baggage-information system according to claim 1, wherein at least one of a beginning and an end of an operation of introducing the baggage items into the system can be read on said dynamically updatable display configuration.

6. The baggage-information system according to claim 1, wherein it is possible to display on said dynamically updatable display configuration a remaining transit time for, and/or a remaining quantity of, baggage located on the baggage-delivery belt.

7. The baggage-information system according to claim 6, wherein a remaining transit time can be determined by linking baggage recognition and transit-time information.

8. The baggage-information system according to claim 1, wherein a total quantity of baggage introduced into the system, and a remaining quantity of baggage located in the system, can be viewed on said dynamically updatable display configuration.

9. A display for a baggage-information system, the display comprising:
at least one dynamically updatable display configuration disposed in an immediate vicinity of a baggage-delivery belt and on which on at least one of the following dynamically updated information can be shown on said dynamically updatable display configuration:
a current flight number of incoming baggage;
a beginning of baggage delivery in minutes and/or seconds;
a total number of baggage items for the current flight which are assigned to the baggage-delivery belt;
a number of outstanding baggage items; and
a transit time remaining until a final baggage item or final baggage items.
